(19) United States
(12) Patent Application Publication
(10) Pub. No.: US 2022/0288620 A1
(43) Pub. Date: Sep. 15, 2022

(54) DEVICE FOR WETTING RECEIVING AND INSERTING AIDS AND/OR CONTAINER OR FRAME CONSTRUCTIONS FOR THE IMPROVED ASSIGNMENT OF PLATE ASSEMBLIES INSIDE A COMPLEX PRODUCTION INSTALLATION

(71) Applicant: SMA SÄCHSISCHE MASCHINEN- UND ANLAGENBAU GMBH, Zwickau (DE)

(72) Inventor: Falk NOFFKE, Reinsdorf (DE)

(73) Assignee: SMA SÄCHSISCHE MASCHINEN- UND ANLAGENBAU GMBH, Zwickau (DE)

(21) Appl. No.: 17/635,296

(22) PCT Filed: Apr. 30, 2020
(86) PCT No.: PCT/DE2020/000085

§ 371 Date: Feb. 14, 2022

(30) Foreign Application Priority Data
Apr. 30, 2019 (DE) 10 2019 003 074.5

(51) Int. Cl. B05C 1/02; H01M 10/04

(52) U.S. Cl. CPC B05C 1/02; H01M 10/0404

(57) ABSTRACT

The invention relates to a device for wetting inserting aids for the improved assignment of plate assemblies outside a complex production installation with a positioning device for the positionally accurate positioning of the wetting device on the inner walls, which are to be wetted, of the inserting aids, and also a wetting device with a supply system for the wetting agent and a cleaning device for cleaning the brush, wherein the positioning device takes the form of a linear axis system which is equipped via separate drives for the movement axes with horizontal and also vertical movement sequences, and wherein a coating brush, which is connected to a wetting agent supply system, is arranged at the end of the positioning device.

### CROSS REFERENCE TO RELATED APPLICATIONS

This application is the National Stage of PCT/DE2020/000085 filed on Apr. 30, 2020, which claims priority under 35 U.S.C. § 119 of German Application No. 10 2019 003 074.5, filed on Apr. 30, 2019, the disclosure of which is incorporated by reference. The international application under PCT article 21(2) was not published in English.

### BACKGROUND OF THE INVENTION

The invention relates to an apparatus for the wetting of the internal surfaces of receiving and inserting aids and/or container or frame constructions, in order to create an improved receiving or allocation of apparatuses to be subsequently introduced into these containers, such as plate assemblies for the fabrication of batteries, for example.

On the basis of the existing minimum space conditions within a complex fabrication system, frequently very little space is available for the realization of additional measures for improvement of the fabrication workflows. Likewise, safety measures within the fabrication system must be taken into consideration, and these also require separate space and additional technical measures. Thus, in common spray systems for wetting or coating with lubricants, the explosion protection within the fabrication system is to be additionally taken into consideration.

For this reason, the task underlying the present invention is to create an additional apparatus for wetting the internal surfaces of a container or frame construction outside the actual fabrication process, which method succeeds with small space requirement and without explosion protection measures. In addition, the apparatus according to the invention is intended to be used at the same time for cleaning of soiling and abrasion residues from the internal surfaces in question.

### SUMMARY

One embodiment of the invention relates to an apparatus for wetting of inserting aids for the improved allocation of plate assemblies outside a complex fabrication system having positioning apparatus for accurate positioning of the wetting apparatus at the internal walls, to be wetted, of the inserting aids, as well as a wetting apparatus having a supply system for the wetting agent and a cleaning apparatus for the cleaning of the brush. This design includes a positioning apparatus which is designed as a linear axis system, which is equipped via separate drives (A) for the movement axes (X, Z) with horizontal and also vertical movement sequences. There is also a coating brush, which is in communication with a wetting-agent supply system, which is disposed at the end of the positioning apparatus.

In at least one embodiment, there is an apparatus for wetting of inserting aids for the improved allocation of plate assemblies outside a complex fabrication system having positioning apparatus for accurate positioning of the wetting apparatus at the internal walls, to be wetted, of the inserting aids, as well as a wetting apparatus having a supply system for the wetting agent and a cleaning apparatus for the cleaning of the brush. With this design, the positioning apparatus is designed as a robotic handling system and the coating brush is disposed on the robotic head and brought up to and positioned at the places to be wetted of the inserting aids via controllable movement sequences of robotic head and arm.

Accordingly, an apparatus for wetting of inserting aids for the improved allocation of plate assemblies, wherein the apparatus itself is disposed outside the complex fabrication system at the maintenance and resting position of the inserting aids, consists of a positioning apparatus for accurate positioning of the likewise disposed wetting apparatus at the internal walls, to be wetted, of the inserting aids.

Furthermore, the apparatus according to the invention consists of a supply system for the wetting agent. As the wetting agent, liquid PTFE is advantageously used as a lubrication-promoting agent.

In a first variant, the positioning apparatus is designed as a linear axis system, which is constructed so that both horizontally and vertically controllable movement sequences may be executed, in order to position the wetting apparatus at the surfaces to be wetted.

A coating brush, which is in communication with a wetting-agent supply system, is disposed at the end of the positioning apparatus.

A cleaning apparatus for the coating brush is likewise disposed as an additional container for rotary separation of the wetting, soiling and abrasion residues. In this case the brush may be cleaned rotationally and/or in a cleaning fluid, disposed in the container, for flushing out the residues.

The arrangement of the apparatus for wetting the inserting aids outside the actual fabrication process and at a place in the vicinity of the resting and/or maintenance station of the auxiliary apparatuses and containers offers the possibility of an undisturbed fabrication workflow.

In a further variant, the apparatus according to the invention may be designed such that the positioning apparatus is designed as a robotic handling system and the coating brush is disposed on the robotic head such that, via controllable movement sequences of the robotic head and arm, it can be brought up to and positioned at the places to be wetted of the receiving and inserting aids and/or container or frame construction for gripping and boxing of plate assemblies in the plate containers or frames.

Here also the arrangement of the robotic handing system is outside the actual fabrication process and at a place in the vicinity of the resting and/or maintenance station of the auxiliary apparatuses and containers.

The wetting brush itself is equipped with an additional drive for rotation. Moreover, the wetting brush may be designed as a brush roller that is horizontally or vertically disposed and/or is swivelable.

Larger areas of the surfaces to be wetted may be wetted more efficiently with the roller brush.

Advantageously, the wetting brushes or brush rollers are equipped with a receiving delivery system of their own is equipped for receiving the wetting agent. Thereby the use of the wetting agent can be organized with low losses and efficiently.

For supply of the brush with wetting agent, a receiving/delivery system disposed above the brush is constructed for receiving and for transfer of the coating agent onto the brushes or the lining of the brushes.

However, the receiving of the wetting agent may also take place in the brush itself and the wetting agent travels via bores from the inside to the brushes or to the lining of the wetting brush.

In this variant also, a cleaning apparatus for the coating brush is provided as an additional container for rotary separation of the wetting, soiling and abrasion residues. Thus the brush may also be cleaned in this case rotationally and/or in a cleaning fluid, disposed in the container, for flushing out the residues.

Both variants also lead to a very efficient low-loss use of the wetting agent and also to the possibility that, for example, explosion protection measures that would otherwise be customary during the use of spray devices, may be omitted.

For continuous supply of the wetting brush with wetting agent, the brush is directly in communication via a ring line with a reservoir container that is connected upstream. For this purpose, the reservoir container is kept under pressure and for assurance of the quality of the wetting agent is provided with a mixing apparatus, for example in the form of a stirring mechanism.

### BRIEF DESCRIPTION OF THE DRAWINGS

The invention will be explained in more detail on the basis of an exemplary embodiment, wherein

FIG. 1 shows a schematic plan view of a positioning apparatus as a linear axis system with drive motor for the linear horizontal and vertical movement of the positioning device together with the wetting brush disposed on it, the receiving and delivery system for the wetting agent, the ring line (6) between the reservoir container for the wetting agent as well as the inserting aids to be wetted and the cleaning container for the coating brush;

FIG. 2 shows a schematic side view of a positioning apparatus as a linear axis system with wetting brush roller disposed vertically on it between the surfaces, to be wetted, of the inserting aids as well as the receiving and delivery system, in communication with the wetting brush roller, for the wetting agent, the ring line (6) between the reservoir container for the wetting agent and the brush.

FIG. 3 shows a schematic view of a positioning apparatus as a robotic handling system with coating brush disposed on the robotic head between the surfaces, to be wetted, of the inserting aids as well as the receiving and delivery system, in communication with the brush, for the wetting agent, the ring line between the reservoir container for the wetting agent and the brush.

### DETAILED DESCRIPTION

### Exemplary Embodiment 1

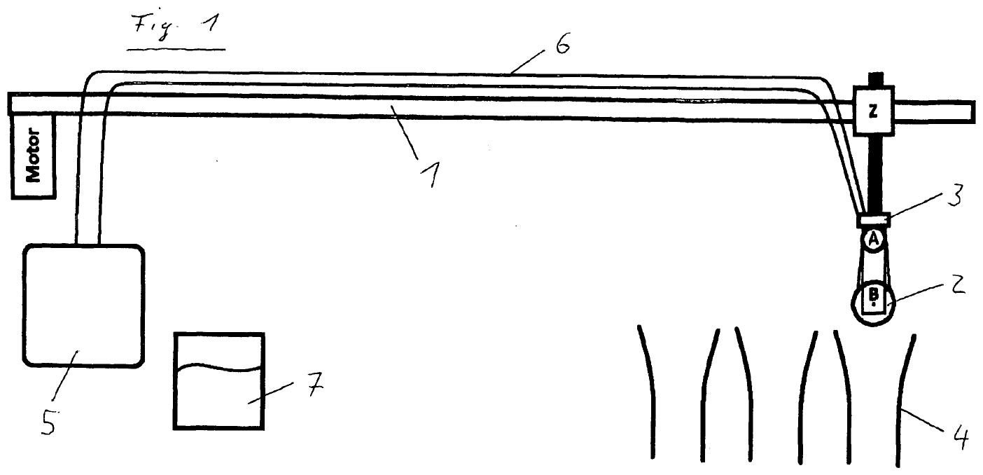

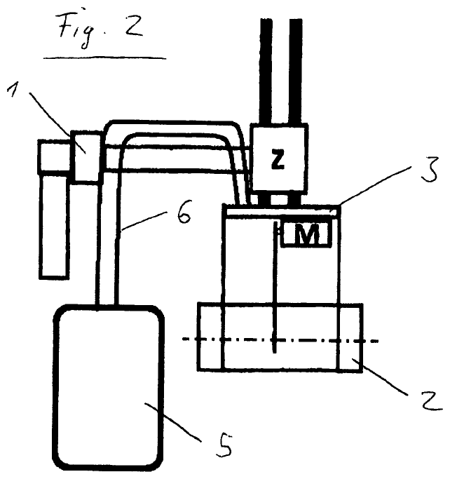

According to FIGS. 1 and 2, the invention relates to an apparatus for wetting of inserting aids 4 in the form of a spreading apparatus for the compartments of a battery housing for improved boxing of battery plate assemblies in these container or frame constructions.

This wetting is used for the improved allocation of the plate assemblies into the container or frame constructions, the so-called battery housings of a complex fabrication system. In particular, the abrasion and the damage to the battery housings and of the battery plate assemblies are supposed to be reliably prevented.

For this purpose, this apparatus for wetting has a positioning apparatus 1 for accurate positioning of the wetting apparatus at the internal walls, to be wetted, of the inserting aids.

Furthermore, the apparatus is provided with a wetting apparatus having a supply system for the wetting agent and a cleaning apparatus 7 for the coating brush.

In this example, the positioning apparatus 1 is designed as a linear axis system having the axes X and Z, and thereby it is equipped with horizontal and also with vertical movement sequences. A coating brush 2, which is in communication with a wetting agent supply system, is disposed at the end of the positioning apparatus 1. This wetting agent supply system consists of the wetting agent receiving unit 3 on the coating brush 2, which is in communication via the ring line 6 for the wetting agent supply with the reservoir container 5, from which the wetting agent is provided. The coating brush 2 is designed to rotate with an additional drive A and is therefore equipped with an additional drive for rotation. The coating brush 2 may be disposed and constructed both horizontally or vertically or as a swivelable brush roller at the end of the linear system.

The coating brush or brush roller 2 is further equipped with a receiving and delivery system 3 used for receiving and delivery of the wetting agent.

For supply of the coating brush 2 with the wetting agent, a receiving and delivery system 3 for receiving and for transfer of the wetting agent onto the brushes or the lining of the brushes is constructed above the coating brush 2. For this purpose, the coating brush 2 is in communication, for the supply with wetting agent, via a ring line 6 with a reservoir container 5 connected upstream and kept under pressure. Preferably a liquid PTFE is used as the wetting agent.

Thus this wetting apparatus is supplied and operational independently of the rest of the system. For cleaning of the coating brush 2, the apparatus for wetting additionally has a cleaning apparatus 7, where the brush 2 can be cleaned of spent coating agents and conditioned for the further use via rapid rotation and/or a dip tub.

The advantages of this solution lie in an autonomous supply of the wetting brush 2 with the wetting agent, independently of the other method workflows of the fabrication system, and in a feed unit that is nevertheless integrated into the fabrication system as a positioning apparatus 1 for wetting the internal walls of the inserting aids during boxing of the battery plate assemblies in the container or frame constructions. Thereby a damage to the battery plate assemblies and the container and frame construction is reliably prevented without impairing the actual method workflow or causing it to be time-consuming due to this measure.

### Exemplary Embodiment 2

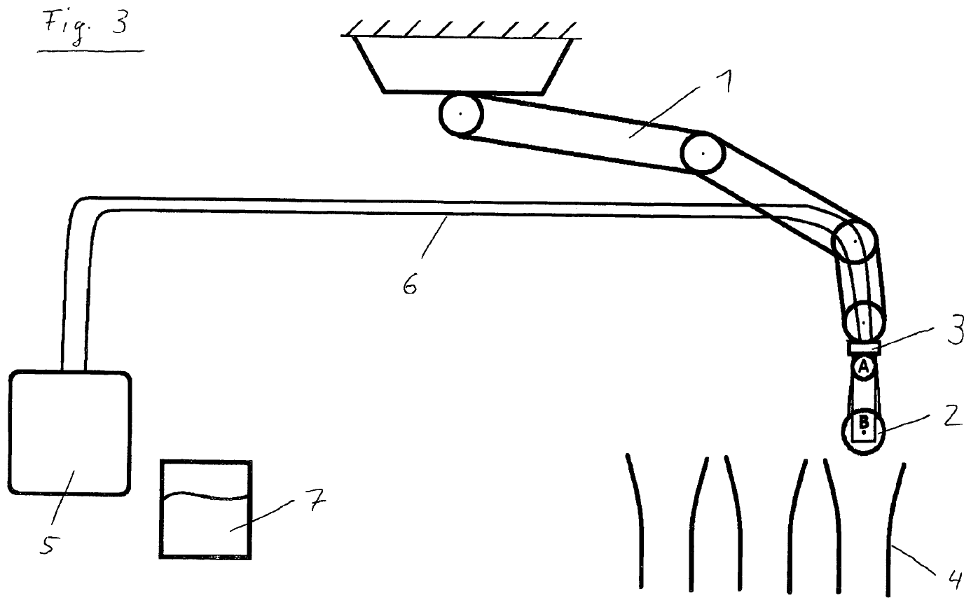

A further variant according to FIG. 3 is the construction of the positioning apparatus 1 as a robotic handling system, wherein the coating brush 2 of the wetting apparatus is then disposed on the robotic head.

Via controllable movement sequences of robotic head and arm, the coating brush 2 can be brought up to and positioned at the places, to be wetted, of the internal walls of the inserting aids 4 during boxing of the battery plate assemblies in the container or frame constructions.

The coating brush 2 is designed to rotate and is therefore equipped with an additional drive A for rotation.

The coating brush 2 may be disposed both horizontally or vertically on the robotic head or designed as a swivelable brush roller.

The coating brush or brush roller 2 is further equipped with a receiving and delivery system 3, which is used for receiving and delivery of the wetting agent. Thus this wetting apparatus is supplied and operational independently of the rest of the system.

For supply of the coating brush 2 with the wetting agent, a wetting agent receiving and delivery system 3 for receiving and for transfer of the wetting agent onto the brushes or the lining of the brushes is constructed above the coating brush 2. For this purpose, the coating brush 2 is in communication, for the supply with wetting agent, via a ring line 6 with a reservoir container 5 connected upstream and kept under pressure. Preferably a liquid PTFE is used as the wetting agent.

For cleaning of the coating brush 2, the apparatus for wetting additionally has a cleaning apparatus 7, where the brush 2 can be cleaned of spent coating agents and conditioned for the further use via rapid rotation and/or a dip tub.

The advantages of this solution lie in an autonomous supply of the wetting brush 2 with the wetting agent, independently of the other method workflows of the fabrication system, and in feed capacity that is to be installed additionally and also subsequently on the fabrication system as a positioning apparatus 1 for wetting the gripping apparatus for gripping of battery plate assemblies for boxing in container or frame constructions and/or for wetting the container or box constructions. Thereby a damage both to the battery plate assemblies and to the container and frame construction is reliably prevented without impairing the actual method workflow or causing it to be time-consuming due to this measure.

### LIST OF REFERENCE SYMBOLS

1 Positioning apparatus as a linear axis system
2 Coating brush
3 Wetting agent receiving and delivery to the brush
4 Inserting aids
5 Reservoir container for the wetting agent
6 Ring line for the wetting agent feed unit
7 Cleaning apparatus for brush
A Drive
X, Z Movement axes

1. An apparatus for wetting of inserting aids for the improved allocation of plate assemblies outside a complex fabrication system having positioning apparatus for accurate positioning of the wetting apparatus at the internal walls, to be wetted, of the inserting aids, as well as a wetting apparatus having a supply system for the wetting agent and a cleaning apparatus for the cleaning of the brush, wherein
the positioning apparatus is designed as a linear axis system, which is equipped via separate drives for the movement axes with horizontal and also vertical movement sequences,
a coating brush, which is in communication with a wetting-agent supply system, is disposed at the end of the positioning apparatus.

2. The apparatus for wetting of inserting aids for the improved allocation of plate assemblies outside a complex fabrication system having positioning apparatus for accurate positioning of the wetting apparatus at the internal walls, to be wetted, of the inserting aids, as well as a wetting apparatus having a supply system for the wetting agent and a cleaning apparatus for the cleaning of the brush, wherein the positioning apparatus is designed as a robotic handling system and the coating brush is disposed on the robotic head and brought up to and positioned at the places to be wetted of the inserting aids via controllable movement sequences of robotic head and arm.

3. The apparatus for wetting of inserting aids according to claim 1, wherein the wetting brush is equipped with an additional drive for rotation.

4. The apparatus for wetting of inserting aids according to claim 2, wherein the brush is designed as a brush roller that is horizontally or vertically disposed and/or is swivelable.

5. The apparatus for wetting of inserting aids according to claim 1, wherein the brush or brush roller is equipped with a receiving and delivery system of its own equipped for receiving the wetting agent.

6. The apparatus for wetting of inserting aids according to claim 1, wherein, for supply of the coating brush with wetting agent, a receiving/delivery system disposed above the brush is constructed for receiving and for transfer of the coating agent onto the brushes or the lining of the brushes.

7. The apparatus for wetting of inserting aids according to claim 1, wherein, for the supply with wetting agent, the brush is in communication via a ring line with a reservoir container disposed upstream and kept under pressure.

8. The apparatus for wetting of inserting aids according to claim 1, wherein a cleaning apparatus functioning for cleaning of the brush is disposed as an additional container for rotary separation of the wetting, soiling and abrasion residues and/or in a cleaning fluid, disposed in the container, for flushing out the residues.

9. The apparatus for wetting of inserting aids according to claim 1, wherein the wetting agent is a liquid PTFE.
